(19) United States
(12) Patent Application Publication
(10) Pub. No.: US 2025/0191341 A1
(43) Pub. Date: Jun. 12, 2025

(54) METHOD AND APPARATUS WITH TRAINING FOR POINT CLOUD FEATURE PREDICTION

(71) Applicant: Samsung Electronics Co., Ltd., Suwon-si (KR)

(72) Inventors: Minki JEONG, Suwon-si (KR); Seungin PARK, Suwon-si (KR); Byung In YOO, Suwon-si (KR); Dongwook LEE, Suwon-si (KR); Sangil JUNG, Suwon-si (KR)

(73) Assignee: Samsung Electronics Co., Ltd., Suwon-si (KR)

(21) Appl. No.: 18/897,271

(22) Filed: Sep. 26, 2024

(30) Foreign Application Priority Data
Dec. 12, 2023 (KR) 10-2023-0179963

(51) Int. Cl. G06V 10/77; G06V 10/40; G06V 10/774; G06V 10/778; G06V 10/82

(52) U.S. Cl. CPC G06V 10/7715; G06V 10/40; G06V 10/774; G06V 10/778; G06V 10/82

(57) ABSTRACT

A processor-implement method includes masking at least a part of voxel data obtained from a point cloud to generate masked voxels, obtaining feature information about the masked voxels from unmasked voxels, which are not masked, through a backbone network, extracting a prediction feature vector from the feature information through a feature prediction model, determining a parameter of a teacher module based on a parameter of the backbone network, extracting a masking feature vector for the masked voxels through the teacher module, and training the backbone network by updating the parameter of the backbone network based on a similarity between the prediction feature vector and the masking feature vector.

### CROSS-REFERENCE TO RELATED APPLICATIONS

This application claims the benefit under 35 USC § 119(a) of Korean Patent Application No. 10-2023-0179963, filed on Dec. 12, 2023 in the Korean Intellectual Property Office, the entire disclosure of which is incorporated herein by reference for all purposes.

### BACKGROUND

### 1. Field

The following description relates to a method and apparatus with training for point cloud feature prediction.

### 2. Description of Related Art

In order to obtain geometric properties of a light detection and ranging (LiDAR) data domain, a training function based on these geometric properties may be used. Geometric properties refer to the properties of a point cloud, such as the position of points, surface normal vector, and occupancy properties, which may be obtained by analyzing distribution of the points inside the point cloud obtained using a LiDAR sensor in a three-dimensional (3D) space.

In order to infer the geometric properties, a training technique may be used to infer the geometric properties of a masked part based on remaining data after a part of a whole point cloud is masked, in order to improve inference ability of a neural network by increasing the difficulty of inference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspect, a processor-implement method includes masking at least a part of voxel data obtained from a point cloud to generate masked voxels, obtaining feature information about the masked voxels from unmasked voxels, which are not masked, through a backbone network, extracting a prediction feature vector from the feature information through a feature prediction model, determining a parameter of a teacher module based on a parameter of the backbone network, extracting a masking feature vector for the masked voxels through the teacher module, and training the backbone network by updating the parameter of the backbone network based on a similarity between the prediction feature vector and the masking feature vector.

The obtaining of the feature information about the masked voxels from the unmasked voxels, which are not masked, through the backbone network may include obtaining geometric information from the unmasked voxels from the backbone network.

The method may include obtaining the geometric information about the masked voxels through a geometric prediction model, and training the parameter of the backbone network based on a loss function between the geometric information about the masked voxels and geometric information obtained from the point cloud.

The determining of the parameter of the teacher module based on the parameter of the backbone network may include updating the parameter of the teacher module at a predetermined interval using the parameter of the backbone network.

The feature prediction model may include a position embedder for extending a dimension of the feature information about the masked voxels, and a transformer-based prediction model for extracting the prediction feature vector for the feature information of the extended dimension.

The extracting of the prediction feature vector from the feature information through the feature prediction model may include extending a dimension for each position for the feature information about the unmasked voxels and a token about the masked voxels, and extracting the prediction feature vector by entering the position, in which the dimension is extended, into the feature prediction model.

The feature information may include a semantic feature of the masked voxels.

The method may include masking at least a part of other voxel data obtained from another point cloud, and obtaining other feature information about other masked voxels from other unmasked voxels, which are not masked, through the trained backbone network.

In one or more general aspects, a non-transitory computer-readable storage medium may store instructions that, when executed by one or more processors, configure the one or more processors to perform and one, any combination, or all of operations and/or methods discussed herein.

In one or more general aspects, a processor-implemented method includes masking at least a part of voxel data obtained from a point cloud to generate masked voxels, and obtaining feature information about the masked voxels from unmasked voxels, which are not masked, through a backbone network that is pre-trained, wherein the backbone network that is pre-trained is a network in which a parameter is trained based on a similarity between a masking feature vector for the masked voxels extracted through a teacher network and a prediction feature vector extracted through the backbone network.

The feature information may include a semantic feature and a geometric feature of the masked voxels.

The parameter of the backbone network that is pre-trained may be trained based on geometric information about the masked voxels and a loss function between the geometric information about the masked voxels and geometric information obtained from the point cloud.

A parameter of the teacher network may be updated at a predetermined interval through an exponential moving average (EMA) of the parameter of the backbone network.

In one or more general aspects, an apparatus includes one or more processors configure to mask at least a part of voxel data obtained from a point cloud to generate masked voxels, obtain feature information about the masked voxels from unmasked voxels, which are not masked, through a backbone network, extract a prediction feature vector from the feature information through a feature prediction model, determine a parameter of a teacher module based on a parameter of the backbone network, extract a masking feature vector for the masked voxels through the teacher module, and train the backbone network by updating the parameter of the backbone network based on a similarity between the prediction feature vector and the masking feature vector.

For the obtaining of the feature information about the masked voxels from the unmasked voxels, which are not masked, through the backbone network, the one or more processors may be configured to obtain geometric information from the unmasked voxels from the backbone network.

The one or more processors may be configured to obtain geometric information about the masked voxels through a geometric prediction model, and train the parameter of the backbone network based on a loss function between the geometric information about the masked voxels and geometric information obtained from the point cloud.

For the determining of the parameter of the teacher module based on the parameter of the backbone network, the one or more processors may be configured to update the parameter of the teacher module at a predetermined interval using the parameter of the backbone network.

The feature prediction model may include a position embedder for extending a dimension of the feature information about the masked voxels, and a transformer-based prediction model for extracting the prediction feature vector for the feature information of the extended dimension.

For the extracting of the prediction feature vector from the feature information through the feature prediction model, the one or more processors may be configured to extend a dimension for each position for a feature information about the unmasked voxels and a token about the masked voxels, and extract the prediction feature vector by entering the position, in which the dimension is extended, into the feature prediction model.

The feature information may include a semantic feature of the masked voxels.

Other features and aspects will be apparent from the following detailed description, the drawings, and the claims.

### BRIEF DESCRIPTION OF THE DRAWINGS

FIG. 1 illustrates an example of a method of training a neural network.

FIG. 2 illustrates an example of a structure for training a neural network.

FIG. 3 illustrates an example of a structure of a feature prediction model.

FIG. 4 illustrates an example of a training method of training a backbone network on a training apparatus.

FIG. 5 illustrates an example of a prediction apparatus for predicting a feature of a point cloud.

FIGS. 6A and 6B illustrate an example of a method of utilizing a pre-trained backbone network.

FIG. 7 illustrates an example of a method of masking a voxel.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated.

Unless otherwise defined, all terms including technical and scientific terms used herein have the same meaning as commonly understood by one of ordinary skill in the art to which the present disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The same name may be used to describe an element included in the examples described above and an element having a common function. Unless otherwise mentioned, the descriptions on the examples may be applicable to the following examples and thus, duplicated descriptions will be omitted for conciseness.

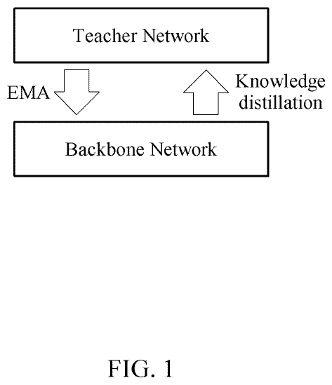

FIG. 1 illustrates an example of a method of training a neural network.

A teacher network of FIG. 1 may be used to train a backbone network of FIG. 1 for extracting feature information about a masked voxel from a point cloud.

The teacher network may be trained to extract semantic feature information for an unmasked voxel in the point cloud by updating a parameter at a predetermined interval through an exponential moving average (EMA). The teacher network may be used to train the backbone network. Using a training method of knowledge distillation, inference ability may be improved to extract a semantic feature from the backbone network as well.

The teacher network may update the parameter at the predetermined interval using a parameter from the backbone network. In addition, the backbone network may be trained based on similarity loss of a feature vector inferred through the teacher network.

In addition to estimating geometric properties of the masked voxel as an objective function of self-supervised training, the backbone network may use an objective function to estimate a feature vector of the masked voxel output by the teacher network. When the feature vector inferred from the teacher network includes the semantic feature of the point cloud, the feature vector may allow semantic inference on the backbone network through training of estimating the semantic feature.

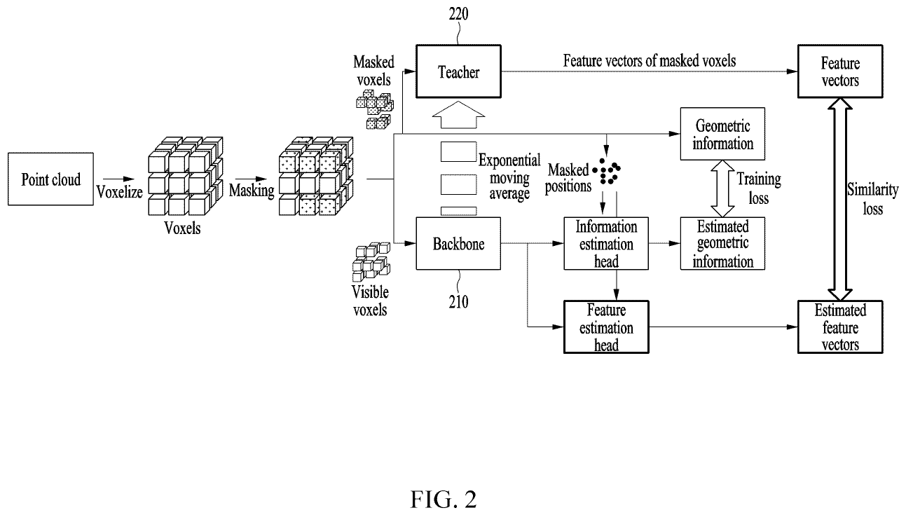

FIG. 2 illustrates an example of a structure for training a neural network.

In response to performing voxelization of a point cloud obtained through a sensor such as a light detection and ranging (LiDAR) sensor, information about a part of voxels of the point cloud may be masked and the masked voxels may be entered into a teacher network 220.

A feature vector of an unmasked voxel, which is not masked, may be predicted through a backbone network 210, and a token of a masked voxel, which replaces a feature vector of the masked voxel, may be extracted.

The feature vector of the unmasked voxel and the token of the masked voxel may be input to multiple head neural networks (e.g., an information prediction model, a feature prediction model, etc.) connected to the backbone network 210. Geometric information about a part of the masked voxel and the feature vector of the masked voxel (hereinafter, referred to as a masking feature vector) may be predicted by multiple head neural networks.

First, ground truth of the masking feature vector may be determined by the teacher network 220. The teacher network 220 may have the same structure as the training backbone network (e.g., the backbone network 210) and a parameter value of the teacher network 220 may be set as an EMA of a parameter value of the backbone network 210 that changes in the course of training.

The backbone network 210 may determine the feature vector of each voxel for the entire unmasked voxel, and a parameter of the backbone network 210 may be trained based on the similarity (e.g., cosine similarity, L2 similarity, etc.) between the masking feature vector determined from the teacher network 220 and a prediction feature vector predicted by the backbone network 210 and the feature prediction model.

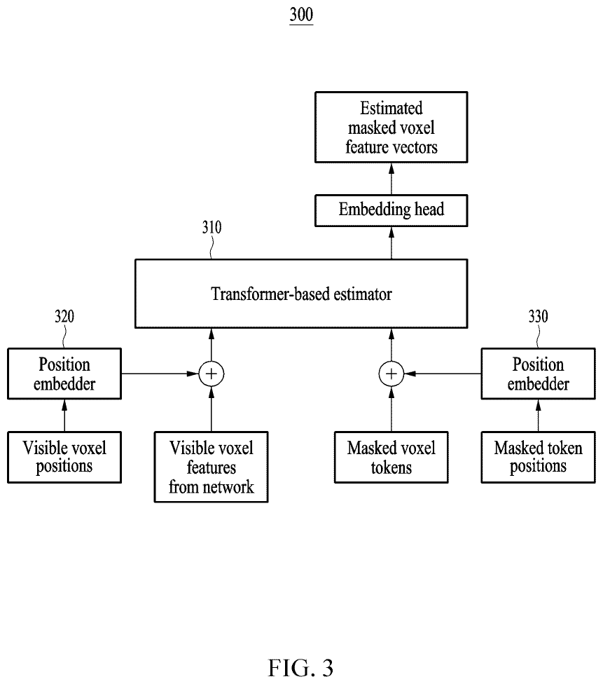

FIG. 3 illustrates an example of a structure of a feature prediction model.

A feature prediction model 300 may be provided to predict a masking feature vector. The feature prediction model 300 may be a transformer-based head neural network. The feature prediction model 300 may include a transformer-based estimator 310 and position embedders 320 and 330.

The feature prediction model 300 may receive position information about a masked voxel in the form of a high-dimensional positional embedding through the position embedders 320 and 330 and may predict a prediction feature vector from a token of the masked voxel and an input of an unmasking feature vector that is an output of a backbone network. A voxel token may include information in a voxel unit. However, when a corresponding voxel does not include position information in three dimensions (3D), the output result of the position embedders 320 and 330 may be used as the position information. More accurate feature prediction may be possible by summing the output of the position embedders 320 and 330 and the voxel token. In other words, feature vectors with high accuracy may be obtained for voxels in a point cloud.

A masked voxel token may be a parameter that is trained with regard to a position where masking of a voxel is performed through a training process. A position of the masked voxel token and a position of an unmasked voxel may correspond to information recorded about a position of the masked voxel during a masking process.

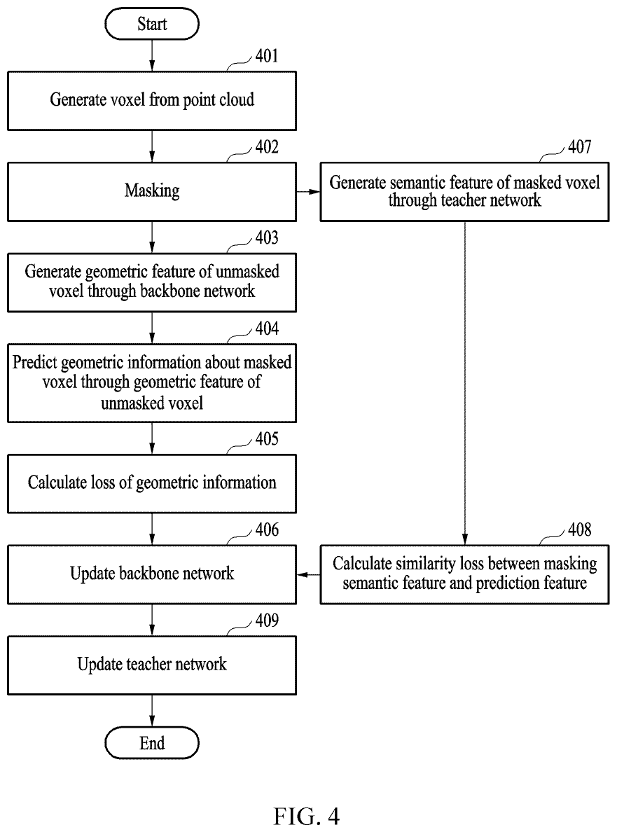

FIG. 4 illustrates an example of a training method of training a backbone network on a training apparatus.

Operations 401 to 409 to be described hereinafter may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein.

A training apparatus for training the properties of a point cloud may train the backbone network through operations 401 to 409.

In operation 401, the training apparatus may generate a voxel from the point cloud. A process of implementing two-dimensional (2D) data included in the point cloud in a 3D form may be included. All voxels may have the same shape and size, and a voxel may have one or more feature values (a parameter). A process of generating a voxel may be executed by an apparatus other than the training apparatus.

In operation 402, masking may be performed on the voxel.

At least a part of pieces of voxel data may be masked so that information in the voxel may not be exposed. The masking process may be performed randomly or according to a predetermined rule, or voxels to be masked may be determined according to the output of a pre-trained neural network.

In operation 403, the training apparatus may generate a geometric feature of an unmasked voxel through the backbone network.

As described above, the backbone network may receive information about the unmasked voxel and may predict the geometric feature.

In operation 404, the training apparatus may predict geometric information about a masked voxel from the geometric feature of the unmasked voxel.

To this end, an information prediction model based on a transformer neural network may predict the geometric information about the masked voxel by receiving, as an input, the geometric information about the masked voxel, a token of the unmasked voxel, and a token of the masked voxel.

In operation 405, the training apparatus may determine loss of the geometric information.

Loss may be determined on the geometric information about the masked voxel extracted through the backbone network and the information prediction model. Loss may be determined, as ground truth, on the geometric information obtained from an actual voxel.

In operation 406, the training apparatus may update the backbone network based on the determined loss.

The training apparatus may update a parameter of the backbone network based on the determined loss. Based on the updated parameter, the backbone network may have a feature of predicting the geometric information about the masked voxel.

In operation 407, the training apparatus may generate a semantic feature of the masked voxel through a teacher network.

The training apparatus may utilize the teacher network to predict the semantic feature by enhancing the properties of the backbone network to predict the geometric information.

When the unmasked voxel is entered into the teacher network, a semantic feature vector of each voxel may be derived.

In the teacher network, a parameter may be set in an EMA method of updating a parameter value at a predetermined interval as the parameter value of the training backbone network changes.

In operation 408, the training apparatus may determine similarity loss between the semantic feature of the masked voxel and a prediction feature of the backbone network.

Subsequently, in operation 406, the training apparatus may update the parameter of the backbone network again.

The training apparatus may update the parameter of the backbone network based on the similarity loss between a masking feature vector extracted from the teacher network and a prediction feature vector extracted from the backbone network. The backbone network, which has been previously updated based on the loss of the geometric information, may be updated again based on the similarity loss due to the semantic feature. The semantic feature vector may be represented as a high-dimensional feature vector.

In order to obtain the prediction feature vector, feature information about the unmasked voxel extracted from the backbone network may be input into a feature prediction model.

A feature prediction model based on a transformer neural network may predict the feature vector for the masked voxel by receiving, as inputs, the feature information about the unmasked voxel, a position of the unmasked voxel, a token of the masked voxel, and a position of each token.

Similarity may be used as cosine similarity, L2 similarity, and similarity of interdependent information.

In operation 409, the training apparatus may update the teacher network.

A parameter of the teacher network may be updated at a predetermined interval through an EMA of the parameter of the backbone network.

With the updated teacher network and the updated backbone network, the training of the backbone network and the teacher network may be repeated back to operation 403. As the training is repeated, the geometric and semantic inference ability of the backbone network may be increased.

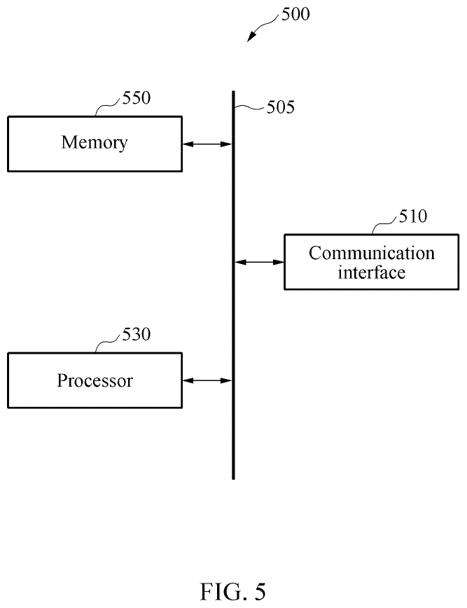

FIG. 5 illustrates an example of a prediction apparatus for predicting a feature of a point cloud.

Referring to FIG. 5, a prediction apparatus 500 may include a communication interface 510 (e.g., one or more interfaces), a processor 530 (e.g., one or more processors), and a memory 550 (e.g., one or more memories). The communication interface 510, the processor 530, and the memory 550 may communicate with each other through a communication bus 505.

The communication interface 510 may receive a point cloud.

The processor 530 may generate a voxel for the point cloud received through the communication interface 510, may mask a part of the voxel, and may enter the part of the voxel into a pre-trained backbone network to obtain a feature vector for the point cloud. The processor 530 may obtain a high-dimensional feature vector including geometric information and a semantic feature for the point cloud.

The backbone network may be trained through supervised training using a teacher network, and the teacher network may include a network in which a parameter value is set as an EMA of a parameter value of the backbone network that changes in a process of training and a predicted feature vector is trained to include the semantic feature of the point cloud.

The memory 550 may store a variety of information generated by the processing process of the processor 530 described above. In addition, the memory 550 may store a variety of data and programs. The memory 550 may include a volatile memory or a non-volatile memory. The memory 550 may include a large-capacity storage medium such as a hard disk to store a variety of data.

In addition, the processor 530 may perform at least one method described with reference to FIGS. 1 to 4 or an algorithm corresponding to the at least one method. The processor 530 may be a hardware-implemented data processing device having a circuit that is physically structured to execute desired operations. The desired operations may include, for example, code or instructions in a program. For example, the memory 550 may include a non-transitory computer-readable storage medium storing instructions that, when executed by the processor 530, configure the processor 530 to perform any one, any combination, or all of the operations and/or methods disclosed herein with reference to FIGS. 1-7. The processor 530 may be implemented as, for example, a central processing unit (CPU), a graphics processing unit (GPU), and/or a neural network processing unit (NPU). For example, the prediction apparatus 500 that is implemented as hardware may include, for example, a microprocessor, a CPU, a processor core, a multi-core processor, a multiprocessor, an application-specific integrated circuit (ASIC), and/or a field-programmable gate array (FPGA).

The processor 530 may execute the program and control the prediction apparatus 500. Program code to be executed by the processor 530 may be stored in the memory 550.

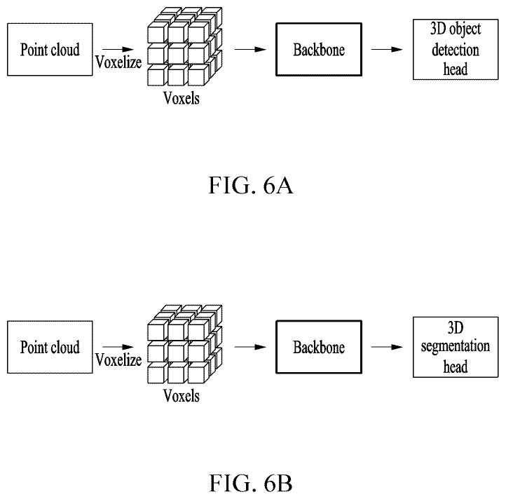

FIGS. 6A and 6B illustrate an example of a method of utilizing a pre-trained backbone network.

The pre-trained backbone network may be used to train a neural network that performs multiple sub-tasks. When the neural network is trained to perform a sub-task, a parameter of the backbone network may be trained again. The parameter of the backbone network trained earlier may provide an effective initial parameter when the sub-task is performed.

A type of a network, as shown in FIGS. 6A and 6B, may be constructed by connecting a head for performing the sub-task to the pre-trained backbone network.

FIG. 6A illustrates an example of training a neural network that detects a 3D object using a pre-trained backbone network and FIG. 6B illustrates an example of training a neural network for 3D segmentation using a pre-trained backbone network.

According to FIGS. 6A and 6B, the backbone network trained through the methods of FIGS. 1 to 4 above is utilized and an output terminal of the backbone network may include a head for 3D object detection and a head for 3D segmentation.

Since the backbone network trained through self-supervised training starts training with the ability to obtain a feature for a point cloud, when training about the backbone network and the heads that guarantee performance for 3D object detection, the method and apparatus of one or more embodiments may achieve the training of the backbone network and the heads with high performance at a high training speed.

A parameter value of the pre-trained backbone network may be used in a neural network to detect a 3D object and perform 3D segmentation. The method and apparatus of one or more embodiments may increase training efficiency and achieve higher performance by using the neural network trained to infer a masked feature vector including semantic information, in addition to the ability to understand the geometric properties of the backbone network.

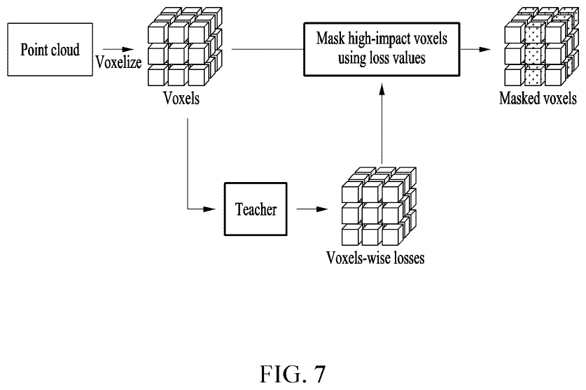

FIG. 7 illustrates an example of a method of masking a voxel.

In general, a process of masking a voxel in a point cloud is performed randomly at a predetermined rate.

A method of masking a voxel may be established by utilizing the information analysis ability of a teacher network. The importance of each voxel may be determined using a loss value for each voxel determined in the teacher network. A priority may be determined according to the determined importance, and a priority of masking may be determined by prioritizing a voxel with high priority. For example, when masking is performed at a rate of 50 percent (%), masking may be performed on a voxel at a rate of 50% according to the determined priority.

The method and apparatus of one or more embodiments may increase the training efficiency of a neural network by prioritizing masking of a voxel with high importance.

The prediction apparatuses, communication interfaces, processors, memories, communication buses, prediction apparatus 500, communication interface 510, processor 530, memory 550, and communication bus 505 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implement method comprising:
masking at least a part of voxel data obtained from a point cloud to generate masked voxels;
obtaining feature information about the masked voxels from unmasked voxels, which are not masked, through a backbone network;
extracting a prediction feature vector from the feature information through a feature prediction model;
determining a parameter of a teacher module based on a parameter of the backbone network;
extracting a masking feature vector for the masked voxels through the teacher module; and
training the backbone network by updating the parameter of the backbone network based on a similarity between the prediction feature vector and the masking feature vector.

2. The method of claim 1, wherein the obtaining of the feature information about the masked voxels from the unmasked voxels, which are not masked, through the backbone network comprises obtaining geometric information from the unmasked voxels from the backbone network.

3. The method of claim 2, further comprising:
obtaining the geometric information about the masked voxels through a geometric prediction model; and
training the parameter of the backbone network based on a loss function between the geometric information about the masked voxels and geometric information obtained from the point cloud.

4. The method of claim 1, wherein the determining of the parameter of the teacher module based on the parameter of the backbone network comprises updating the parameter of the teacher module at a predetermined interval using the parameter of the backbone network.

5. The method of claim 1, wherein the feature prediction model comprises:
a position embedder for extending a dimension of the feature information about the masked voxels; and
a transformer-based prediction model for extracting the prediction feature vector for the feature information of the extended dimension.

6. The method of claim 5, wherein the extracting of the prediction feature vector from the feature information through the feature prediction model comprises:
extending a dimension for each position for the feature information about the unmasked voxels and a token about the masked voxels; and
extracting the prediction feature vector by entering the position, in which the dimension is extended, into the feature prediction model.

7. The method of claim 1, wherein the feature information comprises a semantic feature of the masked voxels.

8. The method of claim 1, further comprising:
masking at least a part of other voxel data obtained from another point cloud; and
obtaining other feature information about other masked voxels from other unmasked voxels, which are not masked, through the trained backbone network.

9. A non-transitory computer-readable storage medium storing instructions that, when executed by one or more processors, configure the one or more processors to perform the method of claim 1.

10. A processor-implemented method comprising:
masking at least a part of voxel data obtained from a point cloud to generate masked voxels; and
obtaining feature information about the masked voxels from unmasked voxels, which are not masked, through a backbone network that is pre-trained;
wherein the backbone network that is pre-trained is a network in which a parameter is trained based on a similarity between a masking feature vector for the masked voxels extracted through a teacher network and a prediction feature vector extracted through the backbone network.

11. The method of claim 10, wherein the feature information comprises a semantic feature and a geometric feature of the masked voxels.

12. The method of claim 10, wherein the parameter of the backbone network that is pre-trained is trained based on geometric information about the masked voxels and a loss function between the geometric information about the masked voxels and geometric information obtained from the point cloud.

13. The method of claim 10, wherein a parameter of the teacher network is updated at a predetermined interval through an exponential moving average (EMA) of the parameter of the backbone network.

14. An apparatus comprising:
one or more processors configure to:
mask at least a part of voxel data obtained from a point cloud to generate masked voxels;
obtain feature information about the masked voxels from unmasked voxels, which are not masked, through a backbone network;
extract a prediction feature vector from the feature information through a feature prediction model;
determine a parameter of a teacher module based on a parameter of the backbone network;
extract a masking feature vector for the masked voxels through the teacher module; and
train the backbone network by updating the parameter of the backbone network based on a similarity between the prediction feature vector and the masking feature vector.

15. The apparatus of claim 14, wherein, for the obtaining of the feature information about the masked voxels from the unmasked voxels, which are not masked, through the backbone network, the one or more processors are configured to obtain geometric information from the unmasked voxels from the backbone network.

16. The apparatus of claim 15, wherein the one or more processors are configured to:
obtain geometric information about the masked voxels through a geometric prediction model; and
train the parameter of the backbone network based on a loss function between the geometric information about the masked voxels and geometric information obtained from the point cloud.

17. The apparatus of claim 14, wherein, for the determining of the parameter of the teacher module based on the parameter of the backbone network, the one or more processors are configured to update the parameter of the teacher module at a predetermined interval using the parameter of the backbone network.

18. The apparatus of claim 14, wherein the feature prediction model comprises:
a position embedder for extending a dimension of the feature information about the masked voxels; and
a transformer-based prediction model for extracting the prediction feature vector for the feature information of the extended dimension.

19. The apparatus of claim 18, wherein, for the extracting of the prediction feature vector from the feature information through the feature prediction model, the one or more processors are configured to:
extend a dimension for each position for a feature information about the unmasked voxels and a token about the masked voxels; and
extract the prediction feature vector by entering the position, in which the dimension is extended, into the feature prediction model.

20. The apparatus of claim 14, wherein the feature information comprises a semantic feature of the masked voxels.
